(19) United States
(12) Patent Application Publication
(10) Pub. No.: US 2006/0008093 A1
(43) Pub. Date: Jan. 12, 2006

(54) Media recorder system and method

(76) Inventor: Max Hamouie, Houston, TX (US)

Correspondence Address: MAX HAMOUIE, 3055 SACE ROAD #200, HOUSTON, TX, 77056, US

(21) Appl. No.: 10/884,270

(22) Filed: Jul. 6, 2004

(51) Int. Cl. H04B 3/00; H04B 5/00

(52) U.S. Cl. 381/77; 381/79

(57) ABSTRACT

A method and system for communicating audio signals. The method comprises receiving the audio signals, each portion of the audio signals being associated with a single one of a plurality of original sounds, such as a single musical instrument, a human voice, or a naturally occurring sound. The method comprises outputting the audio signals to a plurality of audio output devices, such as a set of speakers, each speaker being designated for audio signals of a single original sound. The method further comprises routing each portion of the audio signals from the media player to a single one of the plurality of audio output devices, wherein the portion of the audio signals is representative of a single one of the original sounds.

### BACKGROUND OF THE INVENTION

1. Field of the Invention

The invention relates generally to audio and video recording system and related output devices. More particularly, the invention relates to a media recorder system and method of recording and outputting audio signals with little or no degradation in audible effects and quality.

2. Description of the Related Art

As noted above, the invention relates to audio and video recording systems. There is a need in the media industry to process media (e.g., audio or video) signals not only in accordance with the signal's frequency characteristics. Most existing systems rely heavily on processing signals based on frequency components of media signals. By doing so, such systems fail to preserve the full integrity of contents of media signals. The present invention offers a solution to this problem.

### SUMMARY OF THE INVENTION

In one embodiment, the invention provides a system for communicating audio signals. The system comprises at least one media player configured to receive the audio signals. Each audio signal is associated with a single one of a plurality of original sounds. The system further comprises a plurality of audio output devices, each being configured to receive at a portion of the audio signals from the media player. The portion of the audio signals is representative of a single one of the original sounds. In another embodiment, the invention provides a method of communicating audio signals. The method comprises receiving the audio signals, each portion of the audio signals being associated with a single one of a plurality of original sounds. The method further comprises outputting the audio signals to a plurality of audio output devices. The method further comprises routing each portion of the audio signals from the media player to a single one of the plurality of audio output devices, wherein the portion of the audio signals is representative of a single one of the original sounds.

### BRIEF DESCRIPTION OF THE DRAWINGS

The foregoing features, aspects, and advantages of the present invention will now be described with reference to the drawings of a preferred embodiment that is intended to illustrate and not to limit the invention. The drawings comprise five figures in which:

FIG. 1 shows a media recording system in accordance with one embodiment of the invention.

FIG. 2 shows a media player system in accordance with one embodiment of the invention.

FIG. 3 shows a media player system in accordance with another embodiment of the invention.

FIGS. 4A and 4B show an exemplary audio output device in accordance with one embodiment of the invention.

FIG. 5 shows a flowchart illustrating a method of recording and playing audio in accordance with one embodiment of the invention.

### DETAILED DESCRIPTION OF THE INVENTION

Various inventive features will now be described with reference to a media recorder system and method. Although these features are described as part of a common recorder system, those skilled in the art will recognize that many of these features can be practiced or used independently of others. In addition, the inventive features can be implemented differently than described herein, and/or within a different type of system (such as a cable, satellite, dvd, or any broadcast or non-broadcast system). Accordingly, the following description is intended only to illustrate certain embodiments of the invention, and not to limit the scope of the invention. The scope of the invention is defined only by the appended claims.

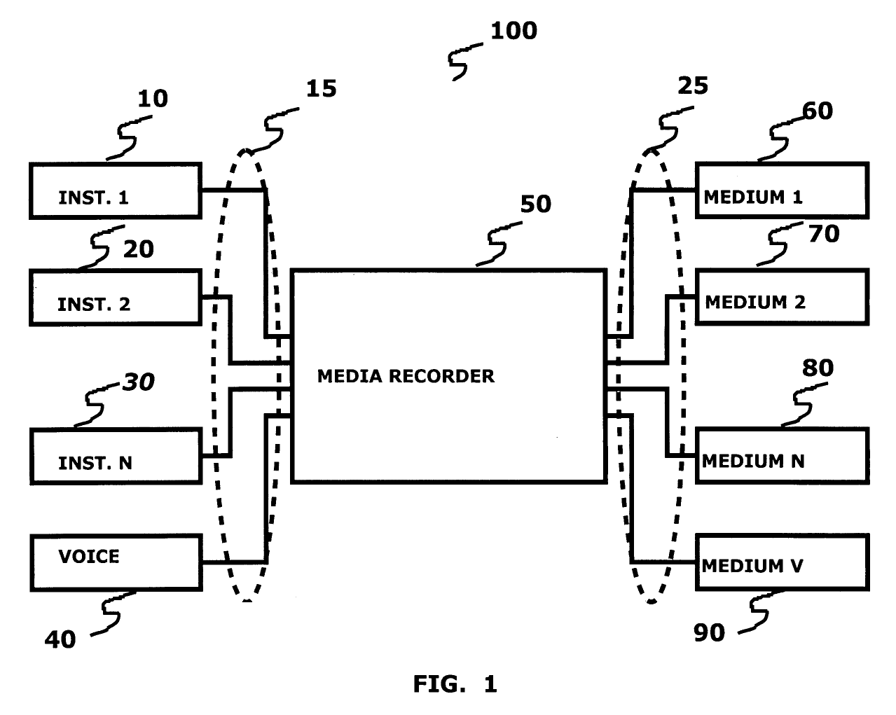

As noted above, FIG. 1 shows a media recording system 100 in accordance with one embodiment of the invention. As shown in FIG. 1, the system 100 comprises a media recorder 50 receiving media signals, such as analog or digital audio and/or video signals, from a media source. In this embodiment, the media source comprises one or more distinct audio sources, such as musical instruments 1 through N as represented by reference numerals 10, 20, and 30. In one embodiment, the musical instrument 1 may be a piano; instrument 2 may be a guitar, etc. The media recorder 50 may comprise any type of recorder that is configured to receive audio signals from said instruments, process, and record the same in analog or preferably digital form onto any type of recordable medium, respectively. The recordable medium may comprise one or more of a compact disc, digital video disc, magnetic tape, electronic memory (e.g., memory on a chip), or any other type of memory. The recordable media is illustrated by reference numerals 60, 70, and 80. In this embodiment, it is desirable to retain the integrity of each audio source separately when recorded on said media. More particularly, it may be desirable to record each instrument separately on its respective medium. For instance, the instrument 10 maybe recorded on the recordable medium 70. In another embodiment, audio signals maybe recorded on the same or multiple recordable media, as long as the distinct integrity of the each sound source is preserved, i.e., the audio source for each instrument is retrievable with little or no degradation in quality of sound. To do so, it is desirable in one embodiment to refrain from electronically mixing audio signals from two or more sources together during processing. By maintaining the separateness of audio signals, audio signals from each instrument may be retrieved as if the instrument is playing separately as it originally would have.

In another embodiment, the recorder 50 may receive an audio signal from any other source, such as natural sound (e.g., tv broadcaster, sound of wind, thunder, etc.) or any other audio source device, e.g., a computer network (e.g., the Internet), a computer, a tape/cd/dvd player or an output from a stereo receiver. Thus, the source Voice 40 may represent one or more microphones receiving sound from one or more human broadcasters in respective languages. Audio signals form the Voice 40 may be recorded in a recordable medium 90 separately, or jointly with other audible signals in the other recordable media.

As further shown in FIG. 1, the system 100 comprises one or more wired or wireless links 15 for receiving the audio signals from respective audio sources 10, 20, etc. The links 15 may comprise a direct audio cable (e.g., RCA), Ethernet link, fiber optic cable, radio frequency (RF) link, a computer bus, or any other link known in the art for carrying audio signals. The system 100 further comprises one or more wired or wireless links 25 for communicating received audio signals to respective media recorders 60, 70, etc. The links 15 may comprise a direct audio cable (e.g., RCA), Ethernet link, fiber optic cable, radio frequency (RF) link, a computer bus, or any other link known in the art for carrying audio signals.

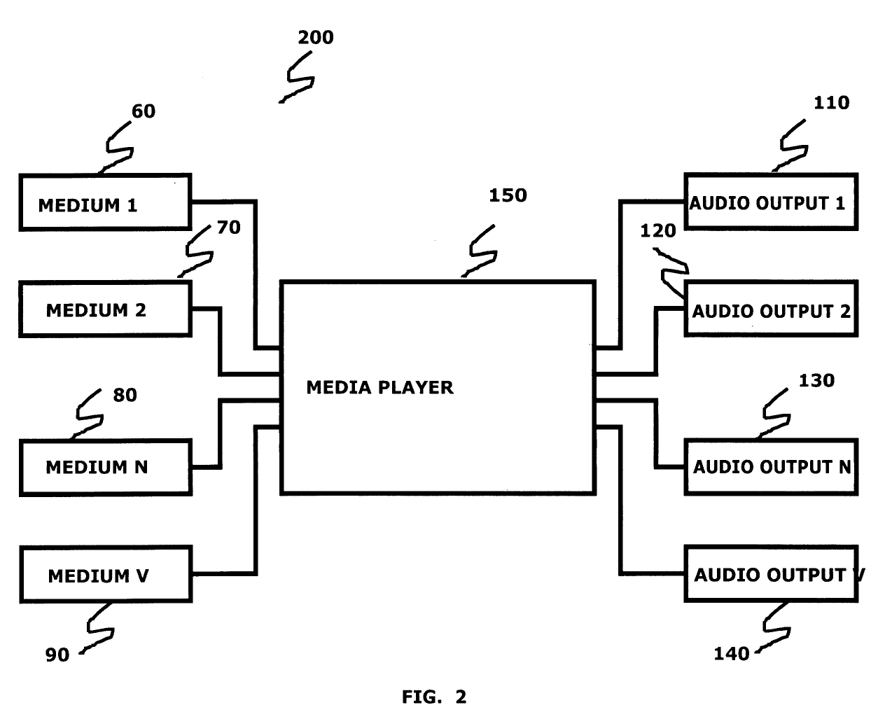

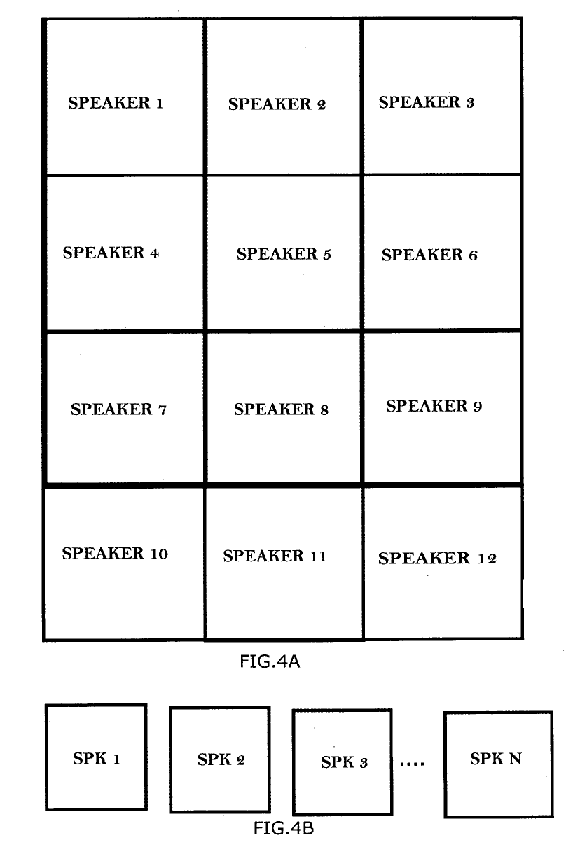

Referring to FIG. 2, a media player system 200 is shown in accordance with one embodiment of the invention. The system 200 comprises a media player 150 accessing one or more of the recordable media 60, 70, 80, and 90. In one embodiment, the media player 150 is configured to play or retrieve audio signals from audio signals from each media 60-90 to audio output devices 110, 120, 130, and 140, respectively. The output devices 110-140 may comprise conventional speakers or a particular speaker device as described in connection with FIG. 4 below. In one embodiment, it is desirable to communicate audio signals from each recordable media 60-90 to its own dedicated output device or speaker 110-140. In configuring system 200 as such, a true recreation of the original sound sources is advantageously achieved. Thus, by using a dedicated speaker for the piano, another for the guitar, a third for the human voice, and so forth, the original setting and distribution of sound is recreated without adverse effects resulting from shortcoming of frequency separation systems. For example, the original physical location of the sound source in its original setting may be duplicated by use of its respective output speaker. Such advantage is diminished when using outputting multiple audio signals on a common output device or speaker. In another embodiment, two or more sound sources may be directed to the same output device or speaker.

In one embodiment, the media player 150 may comprise a plurality of conventional recordable media player, such as plurality of CD, Tape or DVD players (not individually shown). The plurality of players may be synchronized to play concurrently the various media 60-90 and output the audio signals simultaneously and respectively to the output devices or speakers 110-140. In another embodiment, the media player 150 may comprise an integrated multiple media player that is synchronized by a common clock (not shown) to play concurrently the various media 60-90 and output the audio signals simultaneously and respectively to the output devices or speakers 110-140. In yet another embodiment, the media player 150 may comprise one or more computers configured to operate a plurality of media 60-90 players simultaneously. For example, the media player 150 may comprise four computers (not shown in this figure) connected directly or via a network, each computer being installed with a CD/DVD player. The CD/DVD player is equipped to play a single CD/DVD storing audio from a single source (e.g., guitar, piano, human voice, etc.), as discussed above. The four computers may be synchronized using any synchronization method, e.g., by connecting the four computers to a common local server or to a server equipped with synchronizing time over the Internet. Once the four computers are synchronized, a software program (e.g., windows based) may be configured to run simultaneously on all four computers to play the media players simultaneously. In this embodiment, upon playing the four media players simultaneously, each original sound would output to its respective audio output device, e.g., one of audio outputs 110-140.

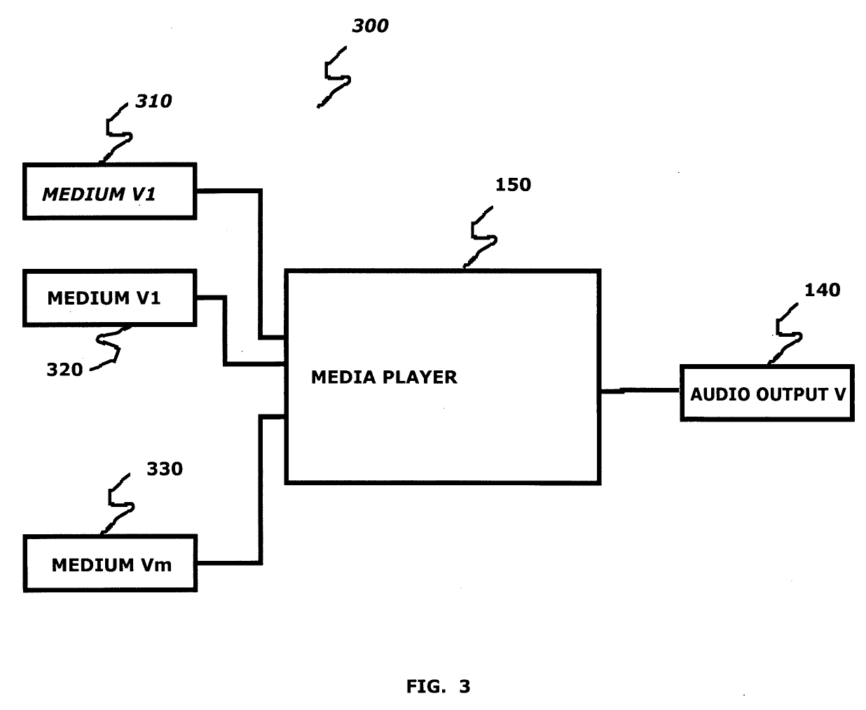

Referring now to FIG. 3, a media player system 300 is shown in accordance with another embodiment of the invention. In this embodiment, the system 300 is configured to play (or retrieve audio signals from) one or more audio media 310, 320, and 330 in a selective manner. In one embodiment, the media 310-330 may each contain or may be transmitting live audio representing, e.g., different languages of an audio program. While watching a TV/DVD/Satellite/Cable/Network/ or Web program or listening to an audio program, a user may be provided with the ability and option to select one audio language for the program being watched. In this embodiment, the media player 150 is configured to respond to the user's selection and select the one or more audio signals from respective medium/media. Thus, the user may select to listen to a multimedia program using the Japanese language, which may be retrieved from or accessed via the medium 320. Accordingly, the media player 150 may select audio signals from the medium 320 for processing and outputting the same to the audio output device 140. In another embodiment, the media selector may select any type of audio signals from any type of source; for instance, a user can select the one of several background audio sounds for a particular program. It is worth noting that one may use the embodiment of the system 300 alone or in conjunction with the features of the systems described above. More particularly, the dedication of each audio source to its respective audio output device can be maintained in conjunction with the selection feature of the system 300.

FIGS. 4A and 4B show an exemplary audio output device in accordance with one embodiment of the invention. As shown in FIG. 4A, the invention provides a unit comprising a plurality of audio output devices (e.g., audio speakers) constructed as a single unit to receive and output audio signals in accordance with one embodiment of the invention. Each individual speaker (e.g., speaker 1, speaker 2, etc.) may be constructed using any speaker technology known in the art. In this embodiment, up to 12 speakers (speaker 1 through speaker 12) are integrated into one speaker or cabinet. Appropriate material, such as wood, polymer based, and/or air gaps, may be used as insulation material to isolate each speaker from another's radio frequency or electrical interferences. The output signals received from, e.g., one or more media players 60-90 (FIG. 2), may be directed to one speaker. For example, the signal from medium 60 (e.g., piano sound) is routed to speaker 1. The signal from medium 70 (e.g., guitar sound) is routed to speaker 2, and so forth. With this configuration, the integrity of each sound source is maintained to the listener as it exists naturally. This principle of sound retention may be equally applied to multimedia applications. For example, as described in connection with FIG. 3 above, an audience of a video program can watch and listen to a program while preserving each sound source in the audience's own living room. Sound of birds may be directed to one speaker, sound of actor or broadcaster to its designated speaker, sound of background piano to its designated speaker, and so forth.

As shown in FIG. 4B, the speaker system shown is similar to that in FIG. 4A, except that each individual speaker is separable. This embodiment provides an advantage to the audience/listener to place each speaker at a position simulating or copying its location in nature. For example, the speaker outputting a human voice may be positioned at a location in the audience's room in the front center, where a person would normally be if present. Background sounds, may be positioned in the back of the room, and so forth.

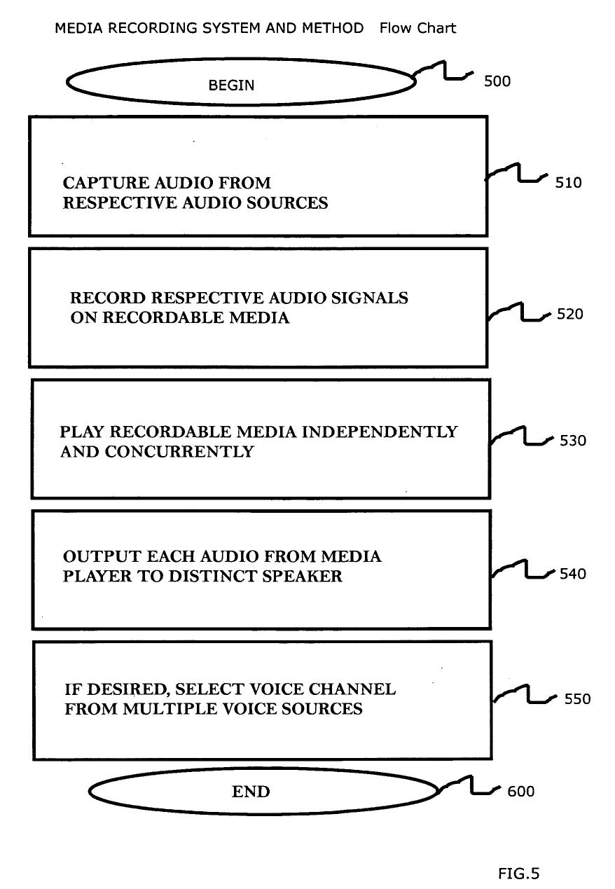

FIG. 5 shows a flowchart illustrating a method of recording and playing audio in accordance with one embodiment of the invention. In the following description, it will be appreciated that the following steps may be performed in a different sequence, certain steps may be skipped, and certain steps may be added. Beginning at block 500, the process begins as indicated in FIG. 5. At block 510, the method comprises capturing an audio sound from a particular audio source. As illustrated in several embodiments described above, the audio source may be any source, e.g., a human voice, sound of nature, a musical instrument, a computer, a RF/satellite receiver, audio signals from a network (e.g., the Internet), etc. This step may be repeated for as many audio sources as desired, e.g., 12. At block 520, the method further comprises recording audio signals from each source in, preferably, a designated recording medium. The audio signals from each source may for example be stored temporarily or permanently in a desired recordable medium. At block 530, each recordable medium (e.g., a CD) may be played substantially in synch or simultaneously with all the other recordable media as described above. At block 540, audio signals from each medium are output to a dedicated or distinct speaker. If desired in some applications, audio signals from two or more audio sources may be routed to a single speaker. At block 550, a member of the audience watching a multimedia application (e.g., a satellite or Internet movie) may select a voice channel from multiple voice channels. For example, the member may select a foreign language (e.g., Japanese) for an English movie, while preserving the integrity of all other audio signals in the movie.

A number of variations and modifications of the invention can also be used. Although the invention is described with reference to specific embodiments thereof, the embodiments are merely illustrative, and not limiting, of the invention, the scope of which is to be determined solely by the appended claims.

What is claimed is:

1. A system for communicating audio signals, the system comprising:
at least one media player configured to receive the audio signals, each portion of the audio signals being associated with a single one of a plurality of original sounds; and
a plurality of audio output devices, each being configured to receive a portion of the audio signals from the media player, wherein the portion of the audio signals is representative of a single one of the original sounds.

2. The system of claim 1, further comprising an interface electrically connecting the at least one media player to the plurality of output devices, the interface being configured to route a first portion of audio signals to a first one of the plurality of output devices, and a second portion of the audio signals to a second one of the plurality of output devices.

3. The system of claim 2, wherein the first portion of audio signals is representative of a first sound source, and the second portion of the audio signals is representative of a second sound source.

4. The system of claim 3, wherein the interface is configured to exclude a third portion of the audio signals from being routed to the first and second output devices, the third portion of the audio signals being representative of a third sound source.

5. The system of claim 3, wherein the first sound source comprises a musical instrument.

6. The system of claim 3, wherein the second sound source comprises an object that generates sound naturally.

7. The system of claim 1, wherein the at least one media player receives the audio signals from at least one recordable medium comprising at least one of a DVD, CD, computer disk, computer memory.

8. The system of claim 1, further comprising at least one media recorder configured to record the audio signals from one of a plurality of audio sources onto a respective recordable medium.

9. The system of claim 1, wherein the at least one media player is configured to read the audio signals from a plurality of recordable media, each storing audio signals from only one of the plurality of original sounds.

10. The system of claim 1, wherein the original sound consists of sound originating from a single sound source.

11. The system of claim 1, wherein the single sound source comprises sound generated by only one of a musical instrument, a computer, a human person, an animal, nature, and any sound generating instrument.

12. A method of communicating audio signals, the method comprising:
receiving the audio signals, each portion of the audio signals being associated with a single one of a plurality of original sounds;
outputting the audio signals to a plurality of audio output devices; and
routing each portion of the audio signals from the media player to a single one of the plurality of audio output devices, wherein the portion of the audio signals is representative of a single one of the original sounds.

13. The method of claim 12, further comprising routing only a first portion of the audio signals to a first one of the plurality of output devices, and routing only a second portion of the audio signals to a second one of the plurality of output devices.

14. The method of claim 13, wherein the first portion of the audio signals is representative of a first sound source, and the second portion of the audio signals is representative of a second sound source.

15. The method of claim 14, further comprising excluding a third portion of the audio signals from being routed to the first and second output devices, the third portion of the audio signals being representative of a third sound source.

16. The method of claim 14, wherein the first sound source comprises a musical instrument.

17. The method of claim 14, wherein the second sound source comprises an object that generates sound naturally.

18. The method of claim 12, wherein receiving the audio signals comprises reading the audio signals from at least one recordable medium comprising at least one of a DVD, CD, computer disk, computer memory.

19. The method of claim 12, further comprising recording the audio signals from one of a plurality of audio sources onto a respective recordable medium.

20. The method of claim 12, further comprising reading the audio signals from a plurality of recordable media, each storing audio signals from only one of the plurality of original sounds.
